(19) United States
(12) Patent Application Publication
(10) Pub. No.: US 2007/0046559 A1
(43) Pub. Date: Mar. 1, 2007

(54) Wideband RFID tag with matching circuit for rotating load impedance

(76) Inventor: Tai Won Youn, Albuquerque, NM (US)

Correspondence Address: BLANK ROME LLP, 600 NEW HAMPSHIRE AVENUE, N.W., WASHINGTON, DC, 20037, US

(21) Appl. No.: 11/509,020

(22) Filed: Aug. 24, 2006

Related U.S. Application Data
(60) Provisional application No. 60/711,410, filed on Aug. 26, 2005.

(51) Int. Cl. H01Q 1/50

(52) U.S. Cl. 343/862; 333/33

(57) ABSTRACT

An RFID tag includes a matching circuit connected between the antenna and the ASIC. The matching circuit rotates the load impedance of the ASIC to provide optimal impedance matching between the antenna and the ASIC over a wide range of operating frequencies. The matching circuit includes a capacitor, first and second microstrips, and a capacitor connected in series. Another capacitor connects ground to a node between the first capacitor and the first microstrip.

### REFERENCE TO RELATED APPLICATION

The present application claims the benefit of U.S. Provisional Patent Application No. 60/711,410, filed Aug. 26, 2005, whose disclosure is hereby incorporated by reference in its entirety into the present disclosure.

### FIELD OF THE INVENTION

The present invention is directed to a wideband RFID tag designed for a wide range of operating frequencies (e.g., 865 MHz through 956 MHz) by utilizing impedance matching.

### DESCRIPTION OF RELATED ART

Emerging globalization has increased international travel and trade by land, air and sea. That has made it more difficult to manage national security, which has become more important then ever. It is recognized that RFID (Radio Frequency Identification) can be used to manage trade by sea by tracking the locations of containers moving from country to country.

The conventional application areas of RFID include transportation, hospitals, wild animal management, inventory controls, and security for border and building access controls. Since most of the target applications have traditionally been located in the United States, the operating frequency range is 902 MHz through 928 MHz. By the nature of the relatively narrow band, the RFID antenna in a tag is matched to the RFID ASIC through a simple matching circuit having a few matching components.

However, the RFID tags for international containers should work for a much wider band frequency range of 865 MHz through 956 MHz, since the containers are moving between countries with different regulations and operating frequencies. Those requirements impose a challenging engineering task.

In the RFID communications system 100 shown by FIG. 1, when the interrogator (Reader) 102 sends an interrogating RF signal 104 to the transponder (Tag) 106, the Tag 106 sends back digital information 108 including account number to precede the transactions through the wireless digital communication. The reader RF signal might be either modulated or not modulated depending on the operating mode.

The system performance is determined by the Tag receiver sensitivity, the distance between Reader and Tag antennas 110, 112 determined by each customer, and the Reader transmitter RF power that is normally controlled by the individual region or country (i.e. Europe, U.S.).

Low cost Container Tags are needed with the best sensitivity over the entire operating frequency range of 865 MHz through 956 MHz. The main constraints of the Tag designs include the low cost, small package, and the best sensitivity.

The Tag 106 includes an antenna 112, a matching circuit 202, and an RFID ASIC 204 as shown in FIG. 2.

The typical antenna impedances are shown by FIG. 3 and FIG. 4 for the antenna and ASIC respectively. The conjugate of the typical antenna impedance is shown in FIG. 5.

### SUMMARY OF THE INVENTION

It is therefore an object of the invention to meet the above-noted need.

To achieve the above and other objects, the present invention is directed to a matching circuit and an RFID tag using it. The role of the matching circuit is to make conjugate impedance matching between the Antenna and the Tag to deliver the maximum energy from the antenna to the Tag. In other words, in the field of use described above, the best matching circuit would transform the Tag input impedance to the conjugate of the antenna impedance for the entire operating frequency range of 865 MHz to 956 MHz.

The optimum matching circuit is based on the operating frequency range and simplicity to achieve the low cost and small package. Generally there are two different matching circuits based on the impedance transformation. The desired transformed impedance of the ASIC has the high impedance at high frequency (i.e. 0.956 GHz) and the low impedance at low frequency (i.e. 0.865 GHz).

The matching circuit rotates the load impedance of the ASIC to give the desired behavior of the load impedance for matching.

### BRIEF DESCRIPTION OF THE DRAWINGS

A preferred embodiment of the present invention will be disclosed with reference to the drawings, in which:

FIG. 1 is a block diagram of a conventional RFID communication system;

FIG. 2 is a block diagram of a conventional RFID tag;

FIG. 3 is a plot of a typical tag antenna impedance;

FIG. 4 is a plot of a typical RFID ASIC impedance;

FIG. 5 is a plot of a conjugate of the typical tag antenna impedance of FIG. 3;

FIG. 6 is a block diagram of a matching circuit without impedance rotation;

FIG. 7 is a plot of an ASIC impedance transformed by the matching circuit of FIG. 6;

FIG. 8 is a block diagram of a matching circuit with impedance rotation;

FIG. 9 is a plot of an ASIC impedance transformed by the matching circuit of FIG. 8;

FIG. 10 is a block diagram of an equivalent circuit used in RFID design; and

FIG. 11 is a plot showing a sensitivity comparison between the matching circuits of FIGS. 6 and 8.

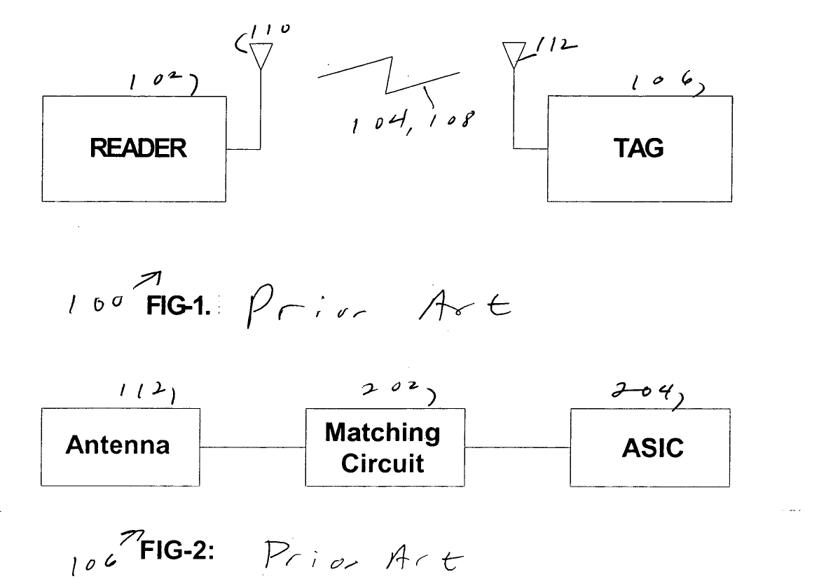

### DETAILED DESCRIPTION OF THE PREFERRED EMBODIMENT

A preferred embodiment will be disclosed with reference to the drawings, in which like reference numerals refer to like elements throughout.

The matching circuit with minimum matching components shown by the block diagram of FIG. 6 will transform the Tag input impedance to the impedance with the low impedance at high frequency (i.e. 0.946 MHz) and the high impedance at low frequency (i.e. 0.865 MHz) as shown by FIG. 7. As shown in FIG. 6, the matching circuit 600 includes an inductor 602 connected between the antenna and ground and the following components connected in series between the antenna 112 and the RF ASIC 204: a capacitor 602, a first microstrip 606, a second microstrip 608, and a capacitor 610. The RF ASIC 204 is also connected to ground.

Since the transformed impedance is the opposite of the desired impedance shown by FIG. 5, that matching circuit will provide a good matching to the antenna for a rather narrow frequency range (i.e. 902 MHz to 928 MHz).

However, the matching circuit shown by the block diagram of FIG. 8 rotates the Tag input impedance, and leads to the desired impedance with the high impedance at high frequency (i.e. 0.956 MHz) and the low impedance at low frequency (i.e. 0.865 MHz). The matching circuit 800 of FIG. 8 differs from the matching circuit 600 of FIG. 6 in that the inductor 602 is replaced by a capacitor 802 connected from ground to a node between the capacitor 604 and the first microstrip 606.

That matching circuit impedance shown by FIG. 9 provides a good matching to the antenna over a wide band frequency range (i.e. 865 MHz to 956 MHz).

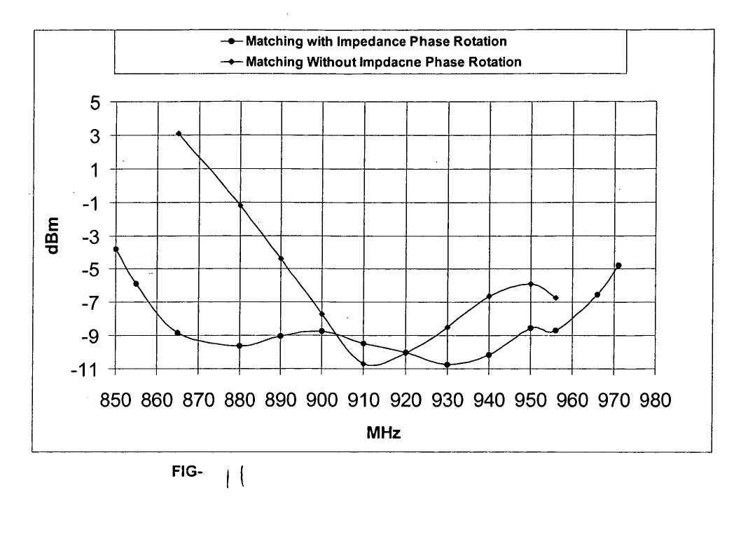

During RF product designs, a complex source impedance (i.e. Zsource=A+j B) must often be matched to another complex load impedance (i.e. Zload=C+j D), as modeled in FIG. 10, where the real part of the impedance is represent by A and C, the imaginary part by B and D, and j before B and D indicates the imaginary part of the complex number.

For a perfect complex conjugate load (i.e. A=C, and B=−D), the source can deliver the power to the load with the 100% matching efficiency (Eff_match).

Eff_match can be defined by the ratio of the power delivered to a load to the power delivered to a perfect complex conjugate load.

However, the source and load impedances generally come with complex impedance.

Since the matching efficiency becomes a complex number due to the complex impedances, the absolute number is taken as shown by EQ-2 for the Eff_match. Eff_match can be written in percentage by Equation (3).

$$I\_load = V\_input / ( ( A + C ) + j ( B + D ) ) \\ P ( perfect load ) = {( V\_input )}^{2} / 4 A \\ \begin{matrix}P ( load ) = {C ( I\_load )}^{2} \\ = {C ( V\_input )}^{2} / {( ( A + C ) + j ( B + D ) )}^{2}\end{matrix} \\ \begin{matrix}Matching Efficiency = P ( load ) / P ( perfect load ) \\ = ( 4 AC ) / {( ( A + C ) + j ( B + D ) )}^{2}\end{matrix} \\ Eff\_match = \vert ( 4 AC ) / {( ( A + C ) + j ( B + D ) )}^{2} \vert \\ Eff\_match ( \% ) = 100 Eff\_match \qquad \begin{matrix} \\ \\ \\ \\ \\ ( 1 ) \\ \\ ( 2 ) \\ ( 3 )\end{matrix}$$

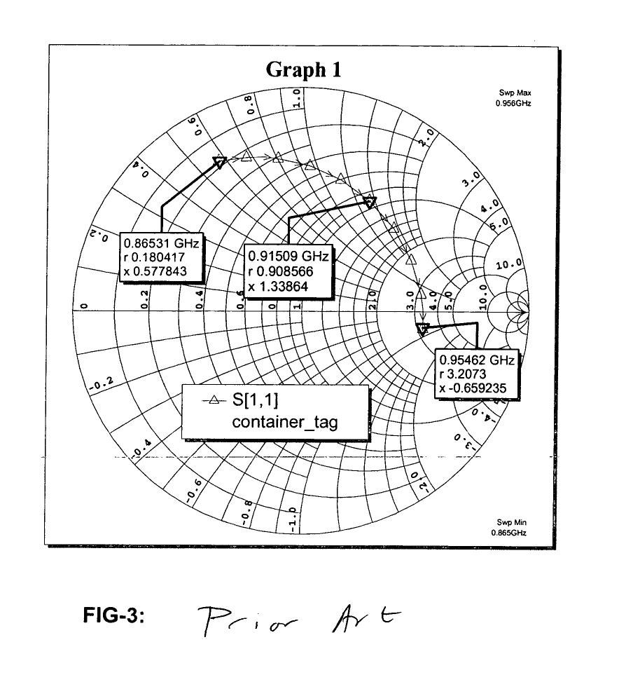

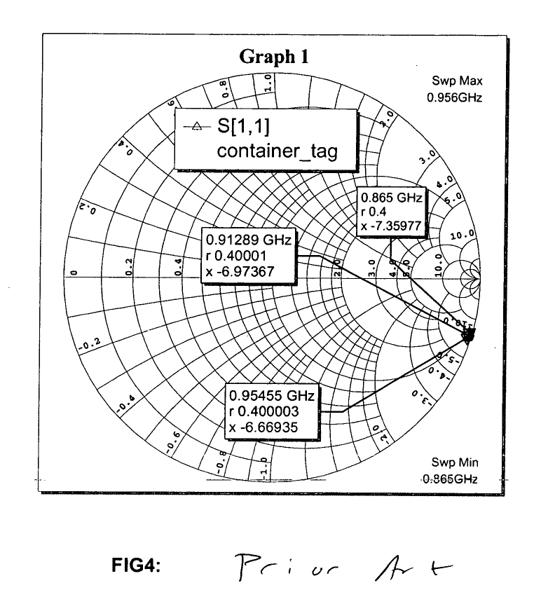

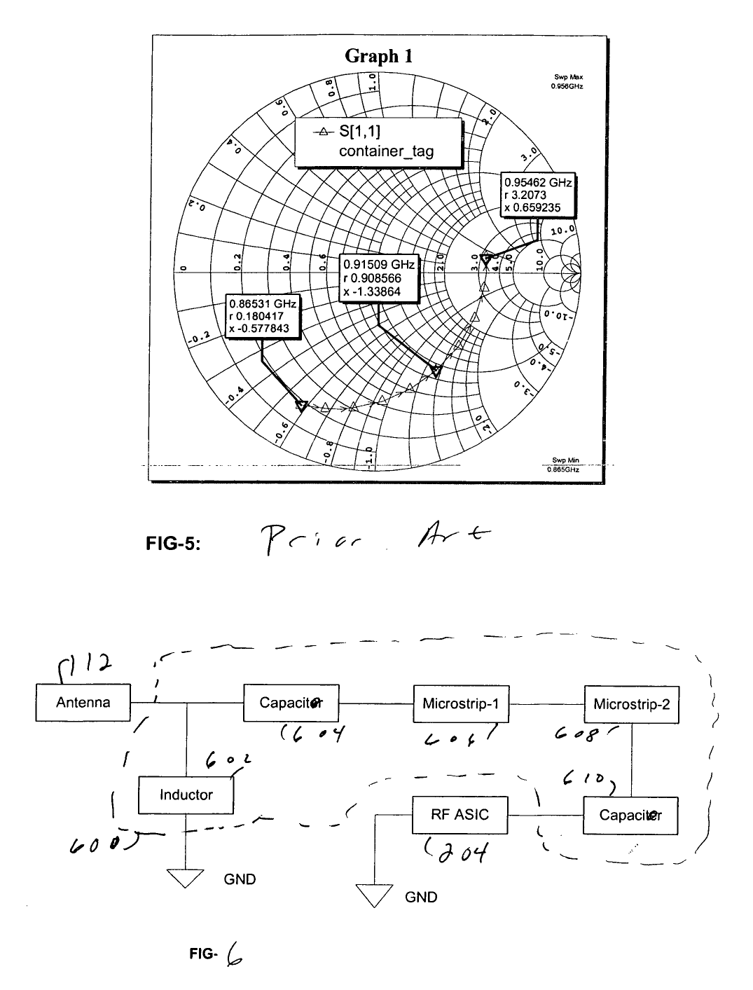

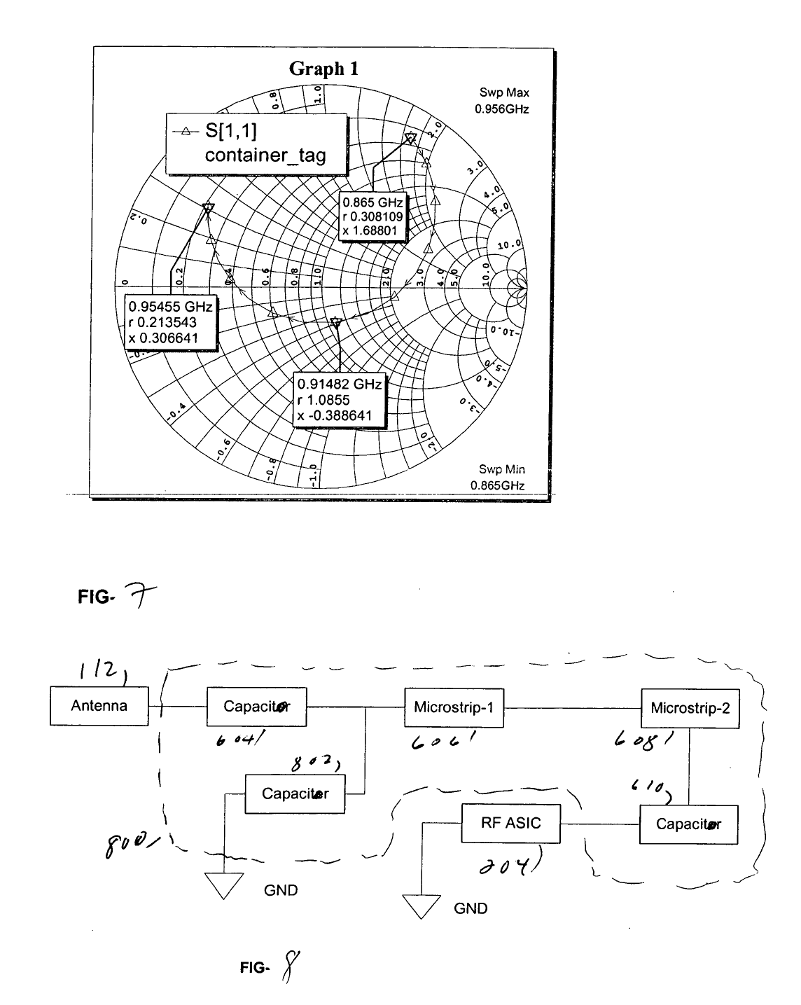

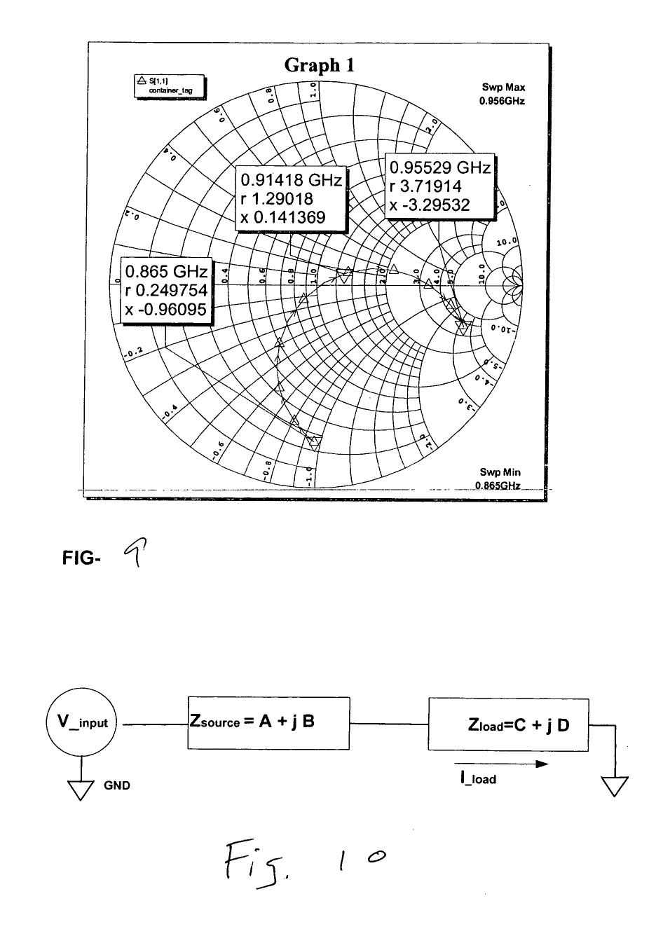

To understand how the matching circuits perform with and without the impedance rotation, the Eff_match (%) is calculated using the antenna source impedance shown by FIG. 3, and the two load impedances shown by FIG. 7 and FIG. 9 as follows:

TABLE 1
Antenna Source Impedance

| 865 MHz | | 915 MHz | | 956 MHz | |
|---|---|---|---|---|---|
| A (Real) | B (Img) | A (Real) | B (Img) | A (Real) | B (Img) |
| 9 Ω | 29 Ω | 45.4 Ω | 67 Ω | 160 Ω | −32 Ω |

TABLE 2
Load Impedance Without Impedance Rotation

| | 865 MHz | | 915 MHz | | 956 MHz | |
|---|---|---|---|---|---|---|
| Frequency | C | | C | | C | |
| Real/Imaginary | (Real) | D (Img) | (Real) | D (Img) | (Real) | D (Img) |
| Normalized | 0.308 | 1.681 | 1.085 | −0.388 | 0.214 | 0.307 |
| Impedance | | | | | | |
| Impedance | 15.4 Ω | 84 Ω | 54 Ω | −19 Ω | 10.7 Ω | 15 Ω |

TABLE 3
Load Impedance With Impedance Rotation

| | 865 MHz | | 915 MHz | | 956 MHz | |
|---|---|---|---|---|---|---|
| Frequency | C | | C | | C | |
| Real/Imaginary | (Real) | D (Img) | (Real) | D (Img) | (Real) | D (Img) |
| Normalized | 0.250 | −0.961 | 1.29 | 0.141 | 3.72 | −3.30 |
| Impedance | | | | | | |
| Impedance | 12.5 Ω | −48 Ω | 64.5 Ω | 7 Ω | 185 Ω | −160 Ω |

TABLE 4
Matching Efficiency (Eff_match (%))

| | 865 MHz | 915 MHz | 956 MHz |
|---|---|---|---|
| Eff_match for load Without | 4% | 81% | 23% |
| Impedance Rotation | | | |
| Eff_match for load With | 54% | 66% | 75% |
| Impedance Rotation | | | |

The Eff_match in Table-4 for the load impedance with the impedance rotation looks slightly detuned to the high frequency due to the difficulty of accurate modeling. However the load impedance with the impedance rotation has still a noticeably wide operating bandwidth of 865 MHz to 956 MHz with better than 50% Eff_match, while load impedance without impedance rotation is working only around 915 MHz with 81% Eff_match.

Tags can be provided without using the impedance phase rotation, and/or with the rotation. The sensitivity test results shown by FIG. 11 indicate a noticeable difference between the two tags. The rotation matching provides the 90 MHz bandwidth from 865 to 956 MHz compared to the non-rotation matching that has only 28 MHz band at around 915 MHz.

While a preferred embodiment of the present invention has been set forth in detail above, those skilled in the art who have reviewed the present disclosure will readily appreciate that other embodiments can be realized within the scope of the invention. For example, numerical values are illustrative rather than limiting, as are the disclosed intended uses for the invention. Therefore, the present invention should be construed as limited only by the appended claims.

What is claimed is:

1. An RFID tag comprising:
an antenna having a source impedance;
an Application Specific Integrated Circuit (ASIC) for performing functions of the tag, the application circuit having a load impedance; and
a matching circuit, connected between the antenna and the ASIC, for matching the source impedance and the load impedance by rotating the load impedance for broadband operation in an operating frequency band.

2. The RFID tag of claim 1, wherein the operating frequency band comprises a band from 865 MHz through 956 MHz.

3. The RFID tag of claim 1, wherein the operating frequency band-width is greater than 40 MHz.

4. The RFID tag of claim 1, wherein the load impedance before rotation increases toward a low end of the operating frequency band.

5. The RFID tag of claim 4, wherein the matching circuit rotates the load impedance such that the rotated load impedance decreases toward the low end of the operating frequency band.

6. The RFID tag of claim 1, wherein the load impedance before rotation decreases toward a high end of the operating frequency band.

7. The RFID tag of claim 6, wherein the matching circuit rotates the load impedance such that the rotated load impedance increases toward the high end of the operating frequency band.

8. The RFID tag of claim 1, wherein the matching circuit comprises:
a first capacitor, a first microstrip, a second microstrip and a second capacitor, connected in series between the antenna and the application circuit; and
a third capacitor, connected from ground to a node between the first capacitor and the first microstrip.

9. A matching circuit component for providing impedance matching between a source impedance and a load impedance, the matching circuit component comprising:
a first connection for being connected to the source impedance;
a second connection for being connected to the load impedance; and
a matching circuit, connected between the first connection and the second connection, for matching the source impedance and the load impedance by rotating the load impedance for broadband operation in an operating frequency band.

10. The matching circuit component of claim 9, wherein the operating frequency band comprises a band from 865 MHz through 956 MHz.

11. The matching circuit component of claim 9, wherein the operating frequency band is greater than 40 MHz.

12. The matching circuit component of claim 9, wherein the load impedance before rotation increases toward a low end of the operating frequency band.

13. The matching circuit component of claim 12, wherein the matching circuit rotates the load impedance such that the rotated load impedance decreases toward the low end of the operating frequency band.

14. The matching circuit component of claim 9, wherein the load impedance before rotation decreases toward a high end of the operating frequency band.

15. The matching circuit component of claim 14, wherein the matching circuit rotates the load impedance such that the rotated load impedance increases toward the high end of the operating frequency band.

16. The matching circuit component of claim 9, wherein the matching circuit comprises:
a first capacitor, a first microstrip, a second microstrip and a second capacitor, connected in series between the first connection and the second connection; and
a third capacitor, connected from ground to a node between the first capacitor and the first microstrip.
